(19) United States
(12) Patent Application Publication
(10) Pub. No.: US 2009/0184930 A1
(43) Pub. Date: Jul. 23, 2009

(54) POSITION DETECTING DISPLAY PANEL

(75) Inventors: Yang Li, Bloomington, MN (US); Haiwen Xi, Prior Lake, MN (US); Insik Jin, Eagan, MN (US); Song S. Xue, Edina, MN (US)

Correspondence Address: INTELLECTUAL PROPERTY GROUP;SEAGATE TECHNOLOGY FILES, FREDRIKSON & BYRON, PA, 200 SOUTH SIXTH ST, SUITE 4000, MINNEAPOLIS, MN, 55402-1425, US

(73) Assignee: SEAGATE TECHNOLOGY LLC, Scotts Valley, CA (US)

(21) Appl. No.: 12/015,966

(22) Filed: Jan. 17, 2008

(51) Int. Cl. G06F 3/046

(52) U.S. Cl. 345/173; 345/179

(57) ABSTRACT

An array of sensors, which is coupled to an array of pixel elements in a position detecting display panel, includes sensors that are each registered with a corresponding pixel element of the array of pixel elements, and that each include a material exhibiting magneto-electric behavior in response to a magnetic field source. Some systems may include the position detecting display panel and at least one separate stylus, which includes the magnetic field source. A voltage source, that is operably coupled to each sensor and each pixel element, applies a voltage across one or more particular pixel elements, according to the magneto-electric behavior of the corresponding sensor(s), when the magnetic field source is brought into proximity the corresponding sensor(s).

### BACKGROUND

Position detecting systems including display panels are known in the art, for example, as an alternative to keyboard and/or mouse input devices for computer systems, which devices are limited where handwriting and/or hand-drawing input is desired. Although a number of position detecting systems, which receive positional information, for example, from a stylus or pen, have been described, there is still a need for position detecting systems incorporating new types of sensors that, when arranged in an array corresponding to an array of pixel elements of a liquid crystal display (LCD), provide relatively high spatial resolution and relatively fast response for a position detecting display panel, without increasing an operating cost and/or complexity of the panel. Thus, the present disclosure pertains to position detecting systems and more particularly position detecting display panels incorporating an array of sensors coupled to an array of pixel elements.

### SUMMARY

An array of sensors, which is coupled to an array of pixel elements in a position detecting display panel of the present disclosure, includes sensors that are each registered with a corresponding pixel element of the array of pixel elements, and that each include a material exhibiting magneto-electric behavior in response to a magnetic field source. Systems of the present disclosure include the position detecting display panel and at least one separate stylus, which includes the magnetic field source. A voltage source, that is operably coupled to each sensor and each pixel element, applies a voltage across one or more particular pixel elements, according to the magneto-electric behavior of the corresponding sensor(s), when the magnetic field source is brought into proximity the corresponding sensor(s).

### BRIEF DESCRIPTION OF THE DRAWINGS

The following drawings are illustrative of particular embodiments of the disclosure and therefore do not limit the scope of the invention. The drawings are not to scale (unless so stated) and are intended for use in conjunction with the explanations in the following detailed description. Embodiments of the disclosure will hereinafter be described in conjunction with the appended drawings, wherein like numerals denote like elements.

FIG. 1A is a schematic cross-section of a position detecting display panel, according to exemplary embodiments of the present disclosure.

FIG. 1B is a schematic plan view of the display panel in conjunction with a stylus, which, together form a position detecting system, according to some embodiments.

FIG. 1C is a schematic representation of a single pixel element and a corresponding sensor element from the display panel shown in FIGS. 1A-B.

FIG. 2 is a schematic representation of a sensor element, according to a first group of embodiments.

FIG. 3 is a schematic representation of a sensor element, according to a second group of embodiments.

FIG. 4 is a simplified block diagram illustrating some position detecting display panel embodiments.

### DETAILED DESCRIPTION

The following detailed description is exemplary in nature and is not intended to limit the scope, applicability, or configuration of the invention in any way. Rather, the following description provides practical illustrations for implementing exemplary embodiments.

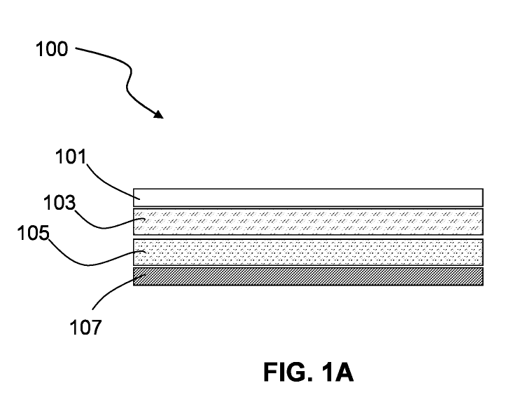

FIG. 1A is a schematic cross-section of a position detecting display panel 100, according to some embodiments of the present disclosure, and FIG. 1B is a schematic plan view of panel 100 in conjunction with a stylus 10, which, together, form a position detecting system, according to some embodiments. FIG. 1A illustrates panel 100 including a first, translucent and protective layer 101, for example, formed from a glass or polymer, overlaying an LCD layer 103, which, in turn, overlays a sensor array layer 105. FIG. 1A further illustrates a plate 107 forming a back side of panel 100 to provide magnetic shielding for sensor array layer 105. FIG. 1B illustrates LCD layer 103, which is seen via a cut-away portion of overlying layer 101, including a plurality of LCD or pixel elements 13 arranged in an array of rows and columns.

In typical LCD's, each pixel element 13 comprises a liquid crystal material contained between two opposing plates, each formed by a transparent electrode and polarizing filter; each of the electrodes, which are in contact with the liquid crystal material, bears a polymer coating that interfaces with the liquid crystal material to affect an alignment of the molecules thereof in the vicinity of the plates. In a twisted nematic device, the liquid crystal molecules in the vicinity of a first electrode are aligned orthogonally to those molecules in the vicinity of a second, opposing electrode, so that the molecules in between are arranged in a helical structure that spans the bulk of the liquid crystal material between the two electrodes and allows light to pass through the pixel element. By controlling a voltage applied across the two electrodes, light passing through each pixel element 13 may be polarized in varying degrees according to the voltage-affected alignment of the liquid crystal molecules.

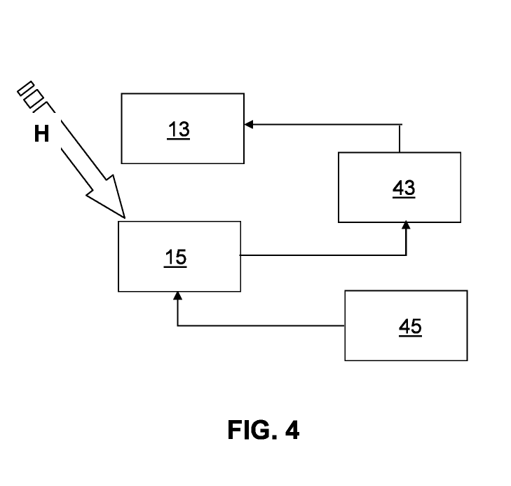

In FIG. 1B, the blackened pixel elements 13 correspond to those which have been affected by an applied voltage, and, according to the illustrated embodiment, the applied voltage for each of these blackened pixels 13 has been dictated by particular positions of stylus 10, in proximity to panel 100, as detected by sensor array layer 105. According to some preferred embodiments, stylus 10 generates a magnetic field, which is detected by each sensor 15 (FIGS. 1C and 4) of an array of sensors 15 in sensor array layer 105, when stylus is positioned in proximity to each sensor 15; upon detection of the magnetic field, each sensor 15, which is registered with a corresponding pixel element 13, for example, as is illustrated in FIGS. 1C and 4, sends a signal to a voltage source 43 (FIG. 4) to apply the voltage across the corresponding pixel element 13. FIG. 4 is a simplified block diagram, which shows a single sensor 15 and corresponding pixel element 13. It should be appreciated that, in position detecting display panels, similar to panel 100, which include a relatively large number of pixels elements, the voltages, applied in response to signals from sensor elements 15, are typically applied by the voltage source to each pixel in a multiplexed fashion.

Stylus 10 may include a permanent magnet to generate the magnetic field, or may include a conductor coil, for example, wound about a ferrite core, to actively generate the field by means of an applied current traveling through the coil. Magnetic fields of varying magnitudes may be generated by the latter type of stylus that includes the conductor coil, for example, to induce a range of signals generated by the sensor elements 15; each signal in the range may correspond to a different color in a range of colors to be displayed by pixels 13. Alternately, a range of signals may be induced by a group of passive-type styluses, each of which include a different permanent magnet generating a different magnitude of magnetic field.

According to some preferred embodiments, each sensor 15 of the array of sensors 15 includes a material that exhibits magneto-electric (ME) behavior in response to a magnetic field, for example, as generated by stylus 10. ME behavior is characterized by a coupling between electric and magnetic fields wherein an electric polarization orientation of the material exhibiting ME behavior is changed by an applied magnetic field, or visa versa. Examples of ME materials may be divided into two categories: 1.) composite materials including a piezoelectric constituent and a magnetostrictive constituent, examples of which include, without limitation, BaTiO3/CoFe2O4, PZT/CoZnFe₂O₄ and PZT/NiZnFe₂O₄ (wherein PZT may be PbZr₁₋ₓTixO₃); and 2.) single-phase multiferroic compounds, examples of which include, without limitation, BiFeO₃, BiMnO₃, Cr₂O₃, Ti₂O₃, GaFeO₃, PbFeNbO₃, LiCOPO₄ and TbPO₄. ME materials have been researched, described, and suggested for sensor applications, for example, by Manfred Fiebig, in “Revival of the Magnetoelectric effect” (J. Phys. D: Appl. Phys. 38, R123 (2005)), and by Van E. Wood and A. E. Austin in “Possible applications for Magnetoelectric materials” (Int. J. Magnetism 5, 303 (1974)).

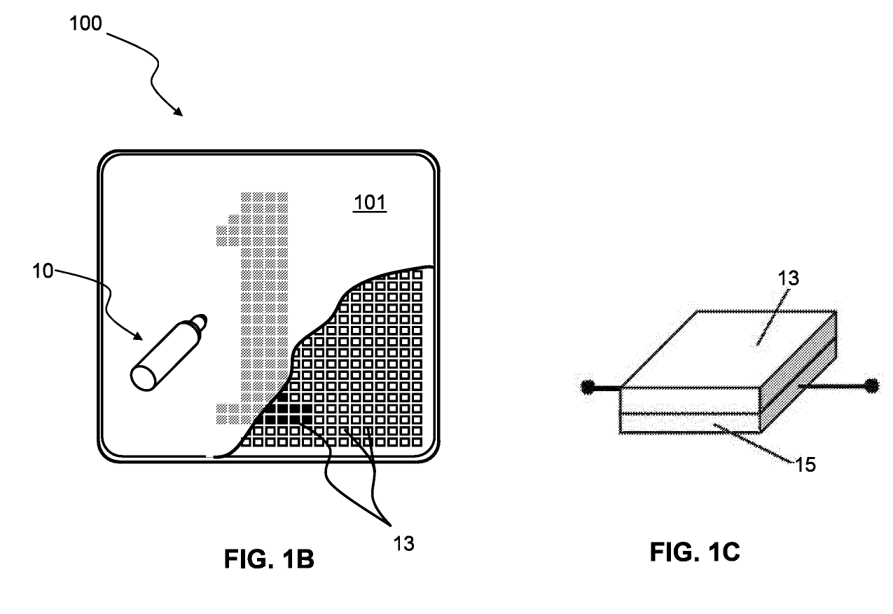

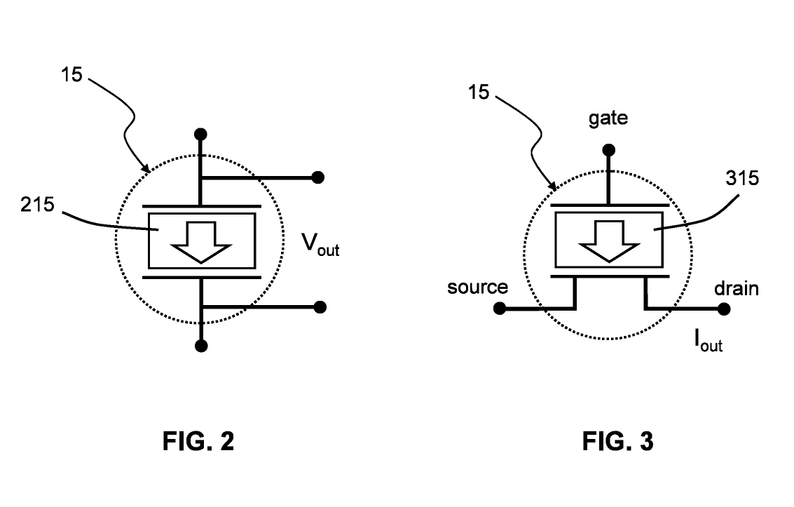

Inventors of the present disclosure propose, for incorporation into a position detecting display panel, for example, display panel 100, two types of sensors 15 that include an ME material. FIGS. 2 and 3 are schematic representations of sensor 15, according to first and second groups of embodiments, respectively, wherein the first group is of a capacitor-type and the second group is of a transistor-type. Sensor array layer 105 (FIG. 1), including either type of sensor, may be manufactured according to standard integrated circuit fabrication methods, which include processes known to those skilled in the art, examples of which processes include, without limitation, sputtering, physical vapor deposition (PVD) and pulsed laser deposition (PLD). Prior to coupling senor array layer 105 to LCD layer 103, a passivating layer is formed over sensor array layer 105 in order to separate sensors 15 from pixel elements 13.

FIG. 2 illustrates sensor 15 embodied as a capacitor, wherein an ME material substrate 215 is inserted between electrode plates thereof. FIG. 2 further illustrates an output voltage Vₒᵤₜ of the capacitor, which would be changed if the electrical polarization orientation of the capacitor, indicated by the arrow, is changed by the ME behavior of substrate 215, in response to a magnetic field, for example, generated by stylus 10. The change in the output voltage of the capacitor, either a transient change, as the polarization orientation changes, or a resulting reversed polarity voltage, comprises the signal that is sent to the voltage source to apply the voltage across the corresponding pixel element 13. According to some preferred embodiments, the ME material selected for substrate 215 has a relatively large electrical polarization, to provide a relatively large output signal, and a relatively low electric coercive field, for setting and resetting of the electrical polarization orientation of the capacitor. Examples of such ME materials may include, without limitation, PZT/CoZnFe₂O₄ and PZT/NiZnFe₂O₄.

FIG. 3 illustrates sensor 15 embodied as a field effect transistor (FET), wherein an ME material substrate 315 is incorporated in place of the typical gate dielectric, according to some embodiments. FIG. 3 further illustrates an output current Iₒᵤₜ of the FET, flowing from source to drain, which would be changed if the electrical polarization orientation of the ME material, indicated by the arrow, is changed, in response to a magnetic field, for example, generated by stylus 10. The change in the output current of the FET comprises the signal that is sent to the voltage source to apply the voltage across the corresponding pixel element 13. According to some preferred embodiments, the ME material selected for substrate 315 has a relatively small electrical polarization and a relatively high electric coercive field, for stability when the transistor is idling. One example of such an ME material is BaTiO₃/CoFe₂O₄.

For position detecting systems including sensor embodiments from each group described in conjunction with FIGS. 2 and 3, the electrical polarization orientation of the incorporated ME materials may be reset by applying a magnetic field in the opposite direction, which field may be applied from a magnetic field generator incorporated in panel 100 or in stylus 10, or by an external generator separate from stylus 10. However, according to some preferred embodiments, an additional voltage source 45 (FIG. 4), which powers sensors 15 and is included in panel 100, applies a voltage to reset the electrical polarization orientation of each sensor 15; the reset voltage is applied across the electrode plates of the capacitor-type sensor, and to the gate of the transistor-type sensor.

The incorporated ME materials may also retain the electrical polarization orientation of sensors 15, as modified by the magnetic field generated by stylus 10, when power to the array of sensors 15 is turned off. Thus, sensors 15 directly store position detection information and, thereby obviate a need to ‘backup’ the information in a separate data storage system, for example, that employs memory chips. This non-volatility of the positioning detecting system that incorporates sensors 15 can facilitate relatively high speed and efficiency in combination with relatively low power consumption.

In the foregoing detailed description, the invention has been described with reference to specific embodiments. These implementations, as well as others, are within the scope of the appended claims.

We claim:

1. A position detecting display panel comprising:
an array of pixel elements;
an array of sensors, each sensor of the array of sensors being registered with and coupled to a corresponding pixel element of the array of pixel elements, and each sensor comprising a material exhibiting magneto-electric behavior in response to a magnetic field generated by a magnetic field source that is separate from the display panel; and
a voltage source operably coupled to each sensor and to each pixel element to apply a voltage across each pixel element according to the magneto-electric behavior of the corresponding sensor;
wherein, when the magnetic field source is brought into proximity with a particular sensor of the array of sensors and generates a magnetic field, the magneto-electric behavior of the particular sensor sends a signal to the voltage source to apply a voltage across the corresponding pixel element.

2. The panel of claim 1, wherein each sensor is configured as a capacitor incorporating the material, and the magneto-electric behavior exhibited by the material reverses the electrical polarization orientation across the corresponding capacitor thereby inducing a change in an output voltage of the corresponding capacitor, the change in the output voltage being the signal that the sensor sends to the voltage source.

3. The panel of claim 2, wherein the change in the output voltage is a transient change in voltage as the polarization orientation reverses.

4. The panel of claim 2, wherein the change in the output voltage is a resulting reversed polarity voltage.

5. The panel of claim 1, wherein each sensor is configured as a FET incorporating the material, and the magneto-electric behavior exhibited by the material changes an output current flowing from a source of the FET to a drain of the FET, the change in the output current being the signal that the sensor sends to the voltage source.

6. The panel of claim 5, wherein the material is incorporated in place of a gate dielectric of each FET.

7. The panel of claim 1, wherein the material exhibiting magneto-electric behavior is a composite material including a piezoelectric constituent and a magnetostrictive constituent.

8. The panel of claim 1, wherein the material exhibiting magneto-electric behavior is a single-phase multiferroic compound.

9. The panel of claim 1, further comprising:
an additional voltage source operably coupled to each sensor; and
wherein the magneto-electric behavior of the material of each sensor, in response to the magnetic field, comprises a reversal in an electrical polarization of each sensor; and
the additional voltage source powers each sensor and is employed to reset the electrical polarization of each sensor after the reversal in the electrical polarization of each sensor.

10. A position detecting system comprising:
at least one stylus including a magnetic field source; and
a position detecting display panel comprising:
an array of pixel elements;
an array of sensors, each sensor of the array of sensors being registered with and coupled to a corresponding pixel element of the array of pixel elements, and each sensor comprising a material exhibiting magneto-electric behavior in response to a magnetic field generated by the magnetic field source of the at least one stylus; and
a voltage source operably coupled to each sensor and to each pixel element to apply a voltage across each pixel element according to the magneto-electric behavior of the corresponding sensor;
wherein, when the at least one stylus is brought into proximity with a particular sensor of the array of sensors and generates a magnetic field, the magneto-electric behavior of the particular sensor sends a signal to the voltage source to apply a voltage across the corresponding pixel element.

11. The system of claim 10, wherein the at least one stylus comprises a plurality of styluses, and each stylus of the plurality includes a permanent magnet generating a different strength of magnetic field.

12. The system of claim 10, wherein the magnetic field source of the at least one stylus is adapted to generate magnetic fields of varying strength.

13. The system of claim 10, wherein each sensor of the display panel is configured as a capacitor incorporating the material, and the magneto-electric behavior exhibited by the material reverses the polarization orientation across the corresponding capacitor thereby inducing a change in an output voltage of the corresponding capacitor, the change in the output voltage being the signal that the sensor sends to the voltage source.

14. The system of claim 13, wherein the change in the output voltage is a transient change in voltage as the polarization orientation reverses.

15. The system of claim 13, wherein the change in the output voltage is a resulting reversed polarity voltage.

16. The system of claim 10, wherein each sensor of the display panel is configured as a FET incorporating the material, and the magneto-electric behavior exhibited by the material changes an output current flowing from a source of the FET to a drain of the FET, the change in the output current being the signal that the sensor sends to the voltage source.

17. The system of claim 16, wherein the material is incorporated in place of a gate dielectric of each FET.

18. The system of claim 10, wherein the material exhibiting magneto-electric behavior of each sensor of the display panel is a composite material including a piezoelectric constituent and a magnetostrictive constituent.

19. The system of claim 10, wherein the material exhibiting magneto-electric behavior of each sensor of the display panel is a single-phase multiferroic compound.

20. The system of claim 10, wherein:
the panel further comprises an additional voltage source operably coupled to each sensor;
the magneto-electric behavior exhibited by the material of each sensor comprises a reversal in an electrical polarization of each sensor; and
the additional voltage source powers each sensor and is employed to reset the electrical polarization of each sensor after the reversal in the electrical polarization of each sensor.

21. A position detecting display panel comprising:
an array of pixel elements;
an array of sensors, each sensor of the array of sensors being registered with and coupled to a corresponding pixel element of the array of pixel elements, and each sensor comprising a material exhibiting magneto-electric behavior in response to a magnetic field generated by a magnetic field source that is separate from the display panel, the magneto-electric behavior, which is exhibited by the material of each sensor, comprising a reversal in an electrical polarization of each sensor;
a first voltage source operably coupled to each sensor and to each pixel element to apply a voltage across each pixel element according to the magneto-electric behavior of the corresponding sensor; and
a second voltage source operably coupled to each sensor, the second voltage source employed to reset the electrical polarization of each sensor after the reversal in the electrical polarization of each sensor;
wherein, when the magnetic field source is brought into proximity with a particular sensor of the array of sensors and generates a magnetic field, the magneto-electric behavior of the particular sensor sends a signal to the voltage source to apply a voltage across the corresponding pixel element; and
each sensor is configured as one of: a capacitor and a FET.

22. The panel of claim 21, wherein the material exhibiting magneto-electric behavior is a composite material including a piezoelectric constituent and a magnetostrictive constituent.

23. The panel of claim 21, wherein the material exhibiting magneto-electric behavior is a single-phase multiferroic compound.
